(19) United States
(12) Patent Application Publication
(10) Pub. No.: US 2026/0196781 A1
(43) Pub. Date: Jul. 9, 2026

(54) CONNECTOR

(71) Applicant: Yazaki Corporation, Tokyo (JP)

(72) Inventors: Yusuke AOKI, Shizuoka (JP); Naoto IKEYA, Shizuoka (JP); Takashi TSUKAMOTO, Shizuoka (JP); Shoya UEDA, Shizuoka (JP)

(73) Assignee: Yazaki Corporation, Tokyo (JP)

(21) Appl. No.: 19/551,780

(22) Filed: Feb. 27, 2026

Related U.S. Application Data
(63) Continuation of application No. PCT/JP2025/007354, filed on Mar. 3, 2025.

(30) Foreign Application Priority Data
Mar. 26, 2024 (JP) 2024-048979

(51) Int. Cl. H01R 13/66; B60L 53/16

(52) U.S. Cl. CPC H01R 13/6683; B60L 53/16; H01R 2201/26

(57) ABSTRACT

In a connector including a housing in which a terminal is arranged, a terminal holder that is assembled to the housing and holds the terminal in the housing, a thermistor that is arranged in the terminal holder and detects a temperature of the terminal, and a thermistor holder that is assembled to the terminal holder, and holds the thermistor in the terminal holder, the thermistor holder is arranged on a side of the terminal that is exposed from the terminal holder toward the housing, and is fixed to the terminal holder via a fixing portion, the thermistor is fixed to the thermistor holder, and the fixing portion fixes a detection wire that is electrically connected to the thermistor and is exposed from the thermistor holder.

### CROSS-REFERENCE TO RELATED APPLICATIONS

The present application is a continuation of International Application No. PCT/JP2025/007354, filed on March 3, 2025, and based upon and claims the benefit of priority from Japanese Patent Application No. 2024-048979, filed on March 26, 2024, the entire contents of which are incorporated herein by reference.

### TECHNICAL FIELD

The disclosure relates to a connector.

### BACKGROUND

In the related art, a connector includes a housing in which a tab-shaped terminal is arranged, and a retainer as a terminal holder that is assembled to the housing and holds the terminal in the housing. Further, there has been known a connector including a thermistor that is arranged in a retainer and detects a temperature of an electric wire electrically connected to a terminal, and a thermistor holder that is assembled to the retainer and holds the thermistor in the retainer (see Japanese Unexamined Patent Application Publication No. 2017-220355). In this connector, the electric wire is drawn out to a side opposite to the housing from a terminal holding portion provided inside the retainer located on a side opposite to the housing. The thermistor is arranged in the terminal holding portion so as to contact with an outer periphery of the electric wire. The thermistor holder is assembled from a draw-out side of the electric wire toward the terminal holding portion located inside the retainer, and holds the thermistor.

### SUMMARY OF THE INVENTION

Incidentally, in the connector in Japanese Unexamined Patent Application Publication No. 2017-220355 described above, the thermistor holder is assembled toward the inside of the terminal holder from the side opposite to the housing. Thus, it is required to assemble the thermistor holder from a rear end in the draw-out direction of the electric wire and a detection wire of the thermistor, which causes degradation of assemblability. In addition, the thermistor is arranged inside the terminal holder, and hence it is difficult to perform a work of drawing out the detection wire of the thermistor from the inside of the terminal holder, which also causes degradation of assemblability.

In contrast, in order to improve assemblability, it may be considered to arrange the thermistor in the housing so as to contact with the terminal that is exposed from the terminal holder to the housing side, and to assemble the thermistor holder to the housing. However, when the thermistor holder is assembled to the housing, high positioning accuracy of the thermistor holder with respect to the housing is required. In a case where a position of the thermistor holder is deviated with respect to the housing, when the terminal holder is assembled to the housing, the terminal exposed from the terminal holder may collide with the thermistor holder. When a collision between the thermistor holder and the terminal occurs, electrical connection reliability may be degraded.

The present disclosure has been made in view of such problems in the related art. Further, an object of the present disclosure is to provide a connector capable of improving assemblability and maintaining electrical connection reliability.

A connector according to the present embodiment includes a housing in which a tab-shaped terminal is arranged, a terminal holder that is assembled to the housing and holds the terminal in the housing, a thermistor that is arranged in the terminal holder and detects a temperature of the terminal, and a thermistor holder that is assembled to the terminal holder, and holds the thermistor in the terminal holder, wherein the thermistor holder is arranged on a side of the terminal that is exposed from the terminal holder toward the housing, and is fixed to the terminal holder via a fixing portion.

According to the present disclosure, it is possible to provide a connector capable of improving assemblability and maintaining electrical connection reliability.

### BRIEF DESCRIPTION OF DRAWINGS

FIG. 1 is a perspective view illustrating a state in which a terminal holder is assembled to a housing of a connector according the present embodiment.

FIG. 2 is an enlarged view of main parts of the connector according to the present embodiment.

### DETAILED DESCRIPTION OF THE INVENTION

With reference to the drawings, a connector according to the embodiment is described below in detail. Note that the dimensional ratios in the drawings are exaggerated for explanatory purposes, and may differ from the actual ratios.

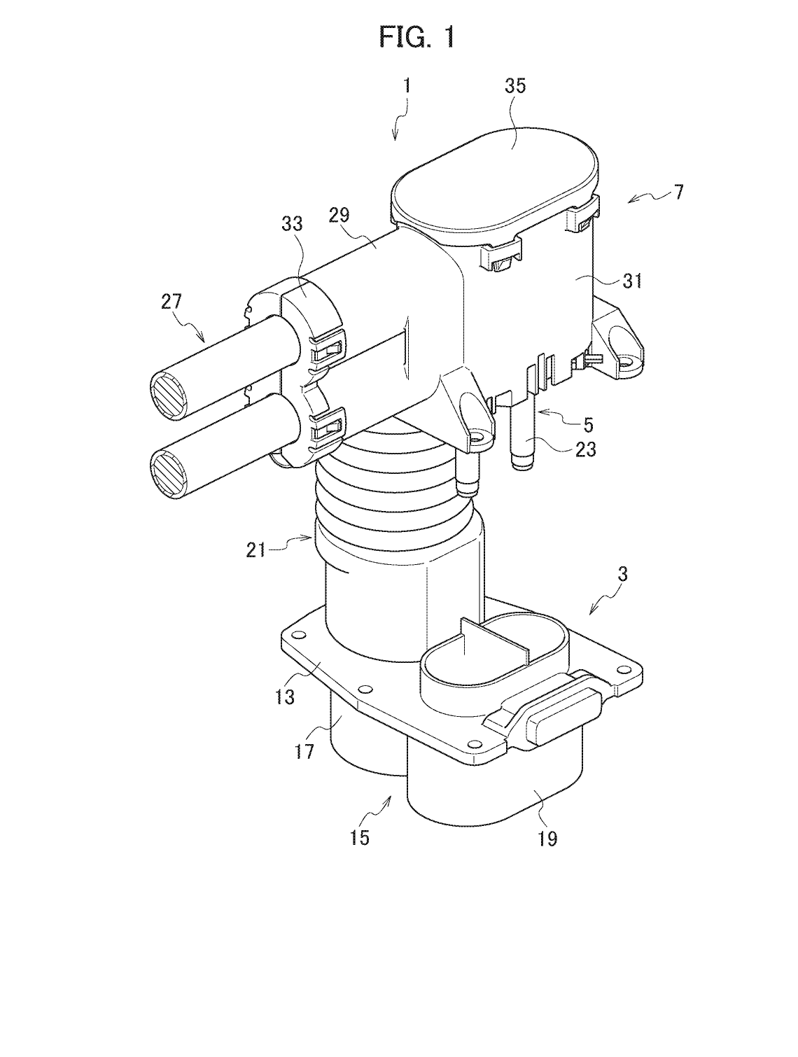

As illustrated in FIG. 1, a connector 1 according to the present embodiment is applied to, for example, a vehicle charging portion for charging a power source mounted on a vehicle such as an electric vehicle and a hybrid vehicle (omitted in illustration). The connector 1 can be fitted with, for example, a charging connector (omitted in illustration) electrically connected to a charging device (omitted in illustration) installed at an electric charging station or the like. By fitting the charging connector with the connector 1, electric power is supplied from the charging device to the power source, and the power source is charged.

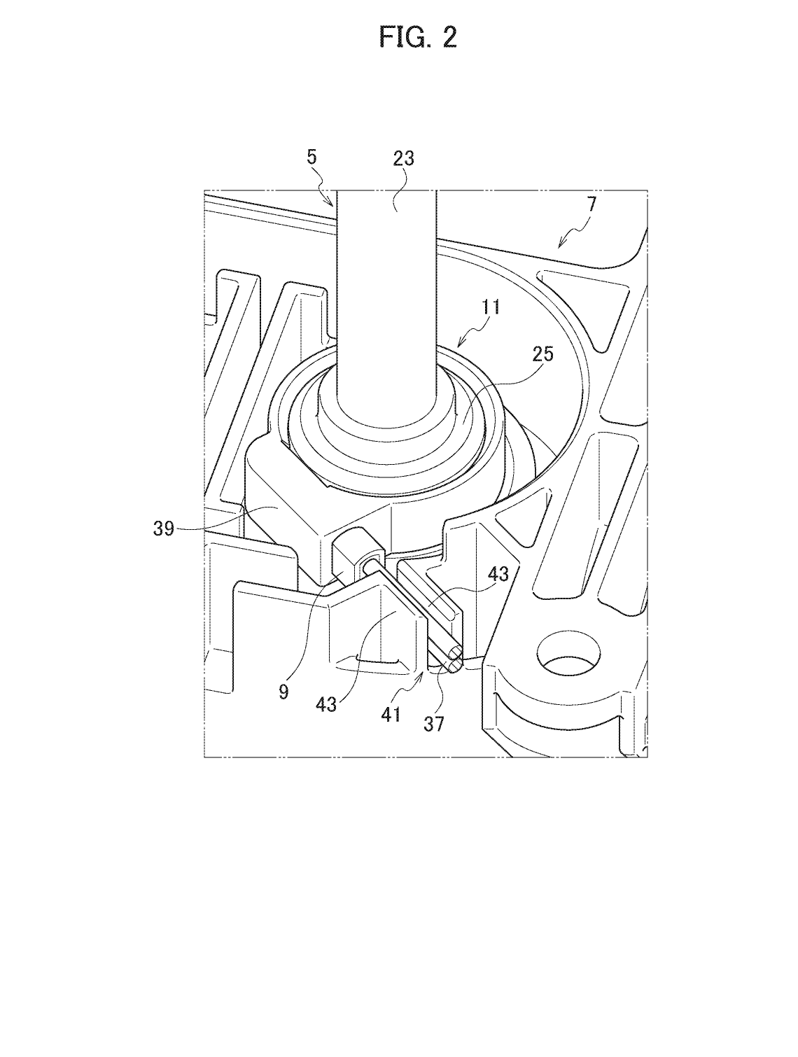

As illustrated in FIG. 1 and FIG. 2, the connector 1 includes a housing 3, a terminal 5, a terminal holder 7, a thermistor 9, and a thermistor holder 11.

The housing 3 is formed of an electrical insulating material such as a synthetic resin. The housing 3 includes a vehicle fixing portion 13 and a fitting portion 15.

The vehicle fixing portion 13 is formed to have a flange shape extending in a planar direction orthogonal to a fitting direction of the connector 1 and the charging connector. For example, in the vehicle charging portion, the vehicle fixing portion 13 fixes the connector 1 to the vehicle via a fixing member (omitted in illustration) such as a bolt or engagement means (omitted in illustration) engaged with each other.

The fitting portion 15 extends in a tubular shape from one surface side of the vehicle fixing portion 13 along the fitting direction of the connector 1 and the charging connector. For example, the fitting portion 15 includes a normal fitting portion 17 with which a normal charging connector (omitted in illustration) can be fitted and a rapid fitting portion 19 with which a rapid charging connector (omitted in illustration) can be fitted.

In the normal fitting portion 17, tab-shaped connecting portions of a plurality of terminals (omitted in illustration) that are electrically connected to mating terminals (omitted in illustration) accommodated in the normal charging connector and are held by a normal terminal holder 21 are arranged. For example, the plurality of terminals held by the normal terminal holder 21 include a plurality of power source terminals and a plurality of communication terminals. The plurality of power source terminals are electrically connected to wire end portions of electric wires (omitted in illustration) electrically connected to the power source. The plurality of communication terminals are electrically connected to wire end portions of electric wires (omitted in illustration) electrically connected to a control unit (omitted in illustration) that controls a charging state. When the normal charging connector is fitted with the normal fitting portion 17, the mating terminal and the terminal are electrically connected, electric power is supplied from the charging device to the power source, and the power source is charged. The normal fitting portion 17 is applied, for example, when there is sufficient time for charging the power source, specifically, when the vehicle is not used for a long time period.

In the rapid fitting portion 19, a plurality of (in this case, two) terminals 5 that are electrically connected to the mating terminals (omitted in illustration) accommodated in the rapid charging connector are arranged. When the rapid charging connector is fitted with the rapid fitting portion 19, the mating terminal and the terminal 5 are electrically connected. Note that the rapid fitting portion 19 is applied, for example, when the power source is charged in a short time, specifically, when the vehicle is not used for a short time period. The fitting portion 15 includes the normal fitting portion 17 and the rapid fitting portion 19, and hence a charging time of the power source can be selected.

The terminal 5 is formed of an electroconductive material, and the plurality of (in this case, two) terminals 5 are used. The terminal 5 includes a tab-shaped connecting portion 23 that extends along the fitting direction of the connector 1 and the charging connector. In a state in which the terminal 5 is arranged in the housing 3, the connecting portion 23 is arranged in the fitting portion 15 (the rapid fitting portion 19) of the housing 3. At an end portion of the connecting portion 23 on a side opposite to the housing 3, a large diameter portion 25 formed to have a diameter larger than the connecting portion 23 is provided as a member continuous with the connecting portion 23. The large diameter portion 25 extends to the side opposite to the connecting portion 23 along the fitting direction of the connector 1 and the charging connector. On a side of the large diameter portion 25 that faces the connecting portion 23, an engaging portion (omitted in illustration) that is engaged with the terminal holder 7 in a detachment direction of the terminal 5 from the housing 3 is provided.

An end portion of the large diameter portion 25 in the extending direction (an end portion positioned inside the terminal holder 7) is electrically connected to a wire end portion of an electric wire 27 electrically connected to the power source. Note that, for example, the electric connection between the terminal 5 and the electric wire 27 involves electrical connection of a relay terminal (omitted in illustration) including a through hole to the wire end portion of the electric wire 27. At an end portion of the large diameter portion 25 of the terminal 5, a columnar portion (omitted in illustration) that can be inserted through the through hole of the relay terminal is provided, and an outer peripheral surface of the columnar portion is formed to have a screw shape. In a state in which the columnar portion is inserted through the through hole of the relay terminal, a nut (omitted in illustration) is fastened to the columnar portion, and thus the terminal 5 and the electric wire 27 can be electrically connected to each other. The terminal 5 and the electric wire 27 are electrically connected to each other via the relay terminal. Thus, even when the terminal 5 is arranged in the housing 3, the terminal 5 and the electric wire 27 can be electrically connected to each other. Consequently, assemblability can be improved. Note that the end portion of the large diameter portion 25 of the terminal 5 may be electrically connected directly to the wire end portion of the electric wire 27.

In a state in which the terminal 5 is arranged in the housing 3, when the charging connector (the rapid charging connector) is fitted with the fitting portion 15 (the rapid fitting portion 19), the terminal 5 is electrically connected to the mating terminal. When the terminal 5 and the mating terminal are electrically connected to each other, electric power is supplied from the charging device to the power source, and the power source is charged. The terminal 5 is held by the terminal holder 7, and the terminal holder 7 is assembled to the housing 3. With this, the arrangement position of the terminal 5 with respect to the housing 3 is maintained.

The terminal holder 7 is formed of an electrical insulating material such as a synthetic resin. The terminal holder 7 includes an electric wire accommodation portion 29 and a terminal accommodation portion 31.

The electric wire accommodation portion 29 extends along a direction orthogonal to an assembly direction of the terminal holder 7 with respect to the housing 3, and accommodates a plurality of (in this case, two) electric wires 27 inside. The electric wire 27 accommodated in the electric wire accommodation portion 29 is arranged so that an end portion thereof on the terminal 5 side is exposed to the terminal accommodation portion 31 side and an end portion thereof on the opposite side is drawn out to the outside of the terminal holder 7. At the end portion of the electric wire accommodation portion 29 from which the electric wire 27 is drawn out, an electric wire holder 33 that holds the electric wire 27 in the electric wire accommodation portion 29 is assembled. By accommodating the electric wire 27 in the electric wire accommodation portion 29, a draw-out direction of the electric wire 27 drawn out from the terminal holder 7 can be defined.

The terminal accommodation portion 31 is a member continuous with the electric wire accommodation portion 29, extends along the assembly direction of the terminal holder 7 with respect to the housing 3, and accommodates the large diameter portions 25 of the plurality of (in this case, two) terminals 5 inside. The side of the terminal accommodation portion 31 that faces the electric wire accommodation portion 29 communicates with the inside of the electric wire accommodation portion 29. On the side of the terminal accommodation portion 31, which is opposite to the housing 3, an opening that enables electrical connection between the electric wire 27 and the terminal 5 is formed. Thus, after the electric wire 27 and the terminal 5 are accommodated in the terminal holder 7, the electric wire 27 and the terminal 5 can be electrically connected to each other. The opening of the terminal accommodation portion 31 is closed by assembling a cover 35 thereto. While the terminal 5 is accommodated in the terminal accommodation portion 31, the connecting portion 23 is exposed to the outside toward the housing 3. At a part of the terminal accommodation portion 31 from which the connecting portion 23 is exposed, an engaged portion (omitted in illustration) that is engaged with the engaging portion of the large diameter portion 25 is provided. By engagement between the engaging portion of the terminal 5 and the engaged portion of the terminal accommodation portion 31, the terminal 5 can be held by the terminal holder 7.

The terminal holder 7 that holds the electric wire 27 and the terminal 5 is assembled to the housing 3 along the same direction as the fitting direction of the connector 1 and the charging connector. The assembly state of the terminal holder 7 with respect to the housing 3 is maintained by a fixing member (omitted in illustration) such as a bolt or engagement means engaged with each other. At the large diameter portion 25 of the terminal 5 that is exposed from the terminal holder 7 to the outside, the thermistor 9 is arranged.

For example, the thermistor 9 is formed to have a rectangular parallelepiped shape. The thermistor 9 contacts with the large diameter portion 25 of the terminal 5 that is exposed from the terminal holder 7 to the outside, and detects a temperature of the terminal 5 during energization between the terminal 5 and the mating terminal. A detection wire 37 is electrically connected to an end portion of the thermistor 9 on one side. The detection wire 37 is drawn out from a space between the housing 3 and the terminal holder 7 to the outside, and is electrically connected to the control unit that controls a charging state. The thermistor 9 is held by the thermistor holder 11, and the thermistor holder 11 is assembled to the terminal holder 7. With this, the arrangement position with respect to the terminal 5 is maintained.

The thermistor holder 11 is formed of an electrical insulating material such as a synthetic resin. The thermistor holder 11 is formed to have an annular shape, and has an inner diameter that is set equivalent to an outer diameter of the large diameter portion 25 of the terminal 5. The thermistor holder 11 is arranged in the terminal holder 7 so that the large diameter portion 25 of the terminal 5 is inserted therethrough. Thus, movement of the thermistor holder 11 in a planar direction intersecting with the axis line of the terminal 5 is restricted, and variation in the arrangement position of the thermistor holder 11 with respect to the terminal holder 7 can be restricted. Note that the inner diameter of the thermistor holder 11 may be set to be slightly smaller than the outer diameter of the large diameter portion 25 of the terminal 5 so that the thermistor holder 11 is press-fitted into the large diameter portion 25. In addition, a part of the thermistor holder 11 in a circumferential direction may be cut out to form a C-like shape, and the thermistor 9 may be assembled to the large diameter portion 25.

The thermistor holder 11 is provided with a holding portion 39 that accommodates the thermistor 9 inside. For example, the thermistor 9 is accommodated in the holding portion 39 in a press-fitting manner, and the thermistor 9 is fixed integrally with the thermistor holder 11. The holding portion 39 is provided with an opening portion (omitted in illustration) that exposes the thermistor 9 to the outside of the thermistor holder 11 so that the thermistor 9 contacts with the large diameter portion 25 of the terminal 5. The detection wire 37 of the thermistor 9 held by the holding portion 39 is fixed to a fixing portion 41 provided to the terminal holder 7, and the thermistor holder 11 is fixed to the terminal holder 7.

The fixing portion 41 is provided on an outer surface of the terminal holder 7 that faces the housing 3, and is arranged so as to be located at least one position in the circumferential direction of the annular thermistor holder 11. In the present embodiment, the fixing portion 41 is arranged at a part where the detection wire 37 drawn out from the thermistor holder 11 is positioned. The fixing portion 41 is formed to have a U-like cross-sectional shape so as to include a pair of nipping pieces 43 and 43 that extend from the outer surface of the terminal holder 7 facing the housing 3 toward the housing 3. A length between the pair of nipping pieces 43 and 43 is set so that the detection wire 37 of the thermistor 9 can be nipped and held therebetween. The pair of nipping pieces 43 and 43 extend along a draw-out direction of the detection wire 37 (a length direction of the detection wire 37). The fixing portion 41 accommodates the detection wire 37 nipped between the pair of nipping pieces 43 and 43, and thus the detection wire 37 is fixed. When the detection wire 37 is fixed to the fixing portion 41, the thermistor holder 11 is fixed to the terminal holder 7, and the arrangement position of the thermistor 9 with respect to the terminal 5 is maintained.

The fixing portion 41 that fixes the thermistor holder 11 is provided at a part of the terminal holder 7 where the terminal 5 is exposed, and hence assemblability can be improved without requiring a work of drawing out the detection wire 37 of the thermistor 9 from the inside of the terminal holder 7. Further, the fixing portion 41 is provided to the terminal holder 7, and hence the terminal 5 exposed from the terminal holder 7 does not collide with the thermistor holder 11 when the terminal holder 7 is assembled to the housing 3. Thus, electrical connection between the terminal 5 and the mating terminal can be achieved stably, and electrical connection reliability can be maintained. In addition, since there is no need to provide the fixing portion 41 for fixing the thermistor holder 11 to the housing 3, high positioning accuracy of the thermistor holder 11 with respect to the housing 3 is not required, and the cost of the housing 3 can be reduced. Further, the fixing portion 41 fixes the detection wire 37 of the thermistor 9. Thus, the design of the thermistor holder 11 can be simplified, and the cost of the thermistor holder 11 can be reduced. In addition, the fixing portion 41 fixes the detection wire 37, and thus the draw-out direction of the detection wire 37 can be defined. Further, the fixing portion 41 extends in the length direction (draw-out direction) of the detection wire 37, and hence the detection wire 37 can be fixed in a wide range, and the thermistor holder 11 can be held stably in the terminal holder 7. Further, the fixing portion 41 is arranged at least one position in the circumferential direction of the thermistor holder 11, and hence movement of the annular thermistor holder 11 about the axis line of the terminal 5 can be restricted. Thus, variation in the arrangement position of the thermistor holder 11 with respect to the terminal holder 7 can be restricted.

As an example of assembly of the connector 1 described above, first, the terminal holder 7 accommodates and holds the electric wire 27 and the terminal 5. Subsequently, the thermistor holder 11 holding the thermistor 9 is assembled to the terminal holder 7 via the fixing portion 41. Note that the thermistor holder 11 may be assembled to the terminal holder 7 before the terminal holder 7 accommodates the electric wire 27 and the terminal 5. Further, the terminal holder 7 is assembled to the housing 3 so that the terminal 5 is arranged in the fitting portion 15 of the housing 3, and then assembly of the connector 1 is completed.

The connector 1 described above includes the housing 3 in which the terminal 5 is arranged, and the terminal holder 7 that is assembled to the housing 3 and holds the terminal 5 in the housing 3. Further, the connector 1 includes the thermistor 9 that is arranged in the terminal holder 7 and detects a temperature of the terminal 5, and the thermistor holder 11 that is assembled to the terminal holder 7 and holds the thermistor 9 in the terminal holder 7. Further, the thermistor holder 11 is arranged on a side of the terminal 5 that is exposed from the terminal holder 7 toward the housing, and is fixed to the terminal holder 7 via the fixing portion 41.

The fixing portion 41 that fixes the thermistor holder 11 is provided at a part of the terminal holder 7 where the terminal 5 is exposed, and hence assemblability can be improved without requiring a work of drawing out the detection wire 37 of the thermistor 9 from the inside of the terminal holder 7. Further, the fixing portion 41 is provided to the terminal holder 7, and hence the terminal 5 exposed from the terminal holder 7 does not collide with the thermistor holder 11 when the terminal holder 7 is assembled to the housing 3. Thus, electrical connection between the terminal 5 and the mating terminal can be achieved stably, and electrical connection reliability can be maintained. In addition, since there is no need to provide the fixing portion 41 for fixing the thermistor holder 11 to the housing 3, high positioning accuracy of the thermistor holder 11 with respect to the housing 3 is not required, and the cost of the housing 3 can be reduced.

Therefore, according to the connector 1 described above, assemblability can be improved, and electrical connection reliability can be maintained.

Further, the thermistor 9 is fixed to the thermistor holder 11. Further, the fixing portion 41 fixes the detection wire 37 that is electrically connected to the thermistor 9 and is exposed from the thermistor holder 11.

Thus, by fixing the detection wire 37 by the fixing portion 41, the draw-out direction of the detection wire 37 can be defined.

Further, the fixing portion 41 is formed so as to accommodate the detection wire 37, and extends in the length direction of the detection wire 37.

Thus, the detection wire 37 can be fixed in a wide range, and the thermistor holder 11 can be held stably in the terminal holder 7.

Further, the thermistor holder 11 is formed to have an annular shape, and the terminal 5 is inserted therethrough and arranged. Further, the fixing portion 41 is arranged at least one position in a circumferential direction of the thermistor holder 11.

The terminal 5 is inserted through and arranged in the thermistor holder 11. Thus, movement of the thermistor holder 11 in the planar direction intersecting with the axis line of the terminal 5 is restricted by the terminal 5. Thus, variation in the arrangement position of the thermistor holder 11 with respect to the terminal holder 7 can be restricted. Further, the fixing portion 41 is arranged at least one position in the circumferential direction of the thermistor holder 11, and hence movement of the annular thermistor holder 11 about the axis line of the terminal 5 can be restricted. Thus, variation in the arrangement position of the thermistor holder 11 with respect to the terminal holder 7 can be restricted.

While some embodiments of the present invention are described above, those embodiments are merely examples, and are not intended to limit the scope of the invention. Those novel embodiments can be implemented in various other forms, and various omissions, substitutions, and changes can be made without departing from the gist of the invention. Those embodiments and modifications thereof are included within the scope and gist of the invention, and are also included within the scope of the invention described in the claims and equivalents thereof.

For example, the fixing portion fixes the detection wire of the thermistor fixed to the thermistor holder, but the present invention is not limited thereto. For example, the fixing portion may be configured as a form that directly fixes the thermistor holder. Specifically, the fixing portion may be an elastically deformable engaging piece engaged with the outer surface of the thermistor holder, or may be an engaging portion engaged with a protrusion provided to the thermistor holder. It is only required to provide such a fixing portion at least one position in the circumferential direction of the thermistor holder.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing in which a terminal is arranged;
a terminal holder that is assembled to the housing and holds the terminal in the housing;
a thermistor that is arranged in the terminal holder and detects a temperature of the terminal; and
a thermistor holder that is assembled to the terminal holder, and holds the thermistor in the terminal holder, wherein
the thermistor holder is arranged on a side of the terminal that is exposed from the terminal holder toward the housing, and is fixed to the terminal holder via a fixing portion,
the thermistor is fixed to the thermistor holder, and
the fixing portion fixes a detection wire that is electrically connected to the thermistor and is exposed from the thermistor holder.

2. The connector according to claim 1, wherein
the fixing portion is formed so as to accommodate the detection wire, and extends in a length direction of the detection wire.

3. The connector according to claim 1, wherein
the thermistor holder is formed to have an annular shape, and the terminal is inserted therethrough and arranged, and
the fixing portion is arranged at least one position in a circumferential direction of the thermistor holder.
